(19) United States
(12) Patent Application Publication
(10) Pub. No.: US 2014/0318703 A1
(43) Pub. Date: Oct. 30, 2014

(54) Continuous production process for polytetrafluoroethylene functional film for electro-mechanical energy conversion

(71) Applicants: Xiangshan Gong, Shanghai (CN); Xiaoqing Zhang, Shanghai (CN); Miya Tsugunari, Shanghai (CN)

(72) Inventors: Xiangshan Gong, Shanghai (CN); Xiaoqing Zhang, Shanghai (CN); Miya Tsugunari, Shanghai (CN)

(73) Assignee: SHANGHAI DAGONG NEW MATERIALS CO., LTD., Shanghai (CN)

(21) Appl. No.: 14/359,470

(22) PCT Filed: May 31, 2012
(86) PCT No.: PCT/CN2012/076329

§ 371 Date: May 20, 2014

(30) Foreign Application Priority Data
Aug. 10, 2011 (CN) 201110227833.8

(51) Int. Cl. B32B 38/00; B32B 37/10; B32B 37/06

(52) U.S. Cl. CPC B32B 38/0008; B32B 37/06; B32B 37/10
USPC 156/272.6; 156/272.2; 156/273.7; 156/274.4

(57) ABSTRACT

A continuous production process for a polytetrafluoroethylene functional film for electro-mechanical energy conversion is disclosed. The process includes a step of thermal bonding a composite film having a micro-porous structure and electrically charging the composite film. The composite film having a micro-porous structure includes one layer of porous polytetrafluoroethylene film sandwiched between two adjacent layers of polytetrafluoroethylene film thermally bonded by two heated rollers. The process also has a step of electrically charging the composite film to obtain a polytetrafluoroethylene piezoelectric electret film. The electrically charging the composite film can be corona-polarizing the composite film by introducing the composite film between an electrode roller and a corona electrode, or introducing the composite film into an electroplating region and attaching electrodes to the upper and lower surfaces thereof, followed by introducing the film to a charging region by a contacting process.

### FIELD OF THE INVENTION

This invention relates to a method for preparing functional films based on polymers, and in particular a continuous production process for producing electromechanical energy conversion films made from polytetrafluoroethylene.

### BACKGROUND OF THE INVENTION

Piezoelectrets, also known as ferroelectrets, are space-charge electrets with piezoelectric effect (i.e., electromechanical energy conversion effect). Such piezoelectric effect in piezoelectrets is associated with the capability of the materials storing real charges in a long term and the special void structure of the materials. The schematic view shown in FIG. 1 indicates the microstructure and the space charge distribution in a piezoelectret material, and the mechanism of piezoelectric effect.

Piezoelectrets are a new class of electromechanical energy conversion materials developed around 1990. Such materials exhibit strong piezoelectric effect comparable to piezoelectric ceramics as well as very good flexibility like polymer ferroelectric materials, such as polyvinylidene fluoride (PVDF) and its copolymers. Such unique features make piezoelectrets very promising in applications of various types of electro-acoustic transducers, pressure sensors, ultrasonic transducers, micro vibration energy harvesters, medical care and so on.

So far the only commercially available piezoelectret is polypropylene (PP) piezoelectret films produced by EmFit Company in Finland. And most of the applications of piezoelectrets are based on PP piezoelectret films presently. However, due to the relatively poor charge storage stability in PP material the working temperature of PP piezoelectrets is less than 60° C. The piezoelectric effect in PP piezoelectrets will decay sharply or even completely disappear if the environment temperature is above this working temperature. For this reason, the development of thermally stable piezoelectrets has been pursued in several laboratories and much progress has been made. But there is no report on thermally stable piezoelectrets in large scale produced by using a continuous production line.

### SUMMARY OF THE INVENTION

Provided herein is a method used for a continuous production process of polytetrafluoroethylene (PTFE) electro-mechanical energy conversion functional films. This process is applicable to mass and continuous production. The products exhibit better thermal stability and piezoelectricity than PP piezoelectret films.

Also provided herein is the PTFE electro-mechanical energy conversion functional film produced by the method mentioned above.

The technical solution provided in this invention is as follows: A continuous production process, for fabricating electromechanical energy conversion functional films based on PTFE, contains two steps of the thermal bonding of the stacks of the layers with micro-pore structure and the electric polarization of such thermally bonded laminated films. The step of the thermal bonding is as the followings: there should be at least two compact PTFE layers and one porous PTFE layer sandwiched between two adjacent compact PTFE films. And then the stacks of the compact and porous PTFE films are fed into the pair of the upper and lower heated press rollers and be thermally bonded there forming the laminated film. The laminated film is finally electrically polarized resulting in PTFE piezoelectret film.

The compact PTFE films mentioned above mean the PTFE films with compact structure produced by various processes, such as turning films, cast films, blow-molded films and so on. The porous PTFE films mentioned above means the PTFE films with porous structure produced by various processes.

On base of the project above, the electrical polarization of the laminated films is as follow: the laminated film is corona charged by putting the laminated film in the area between the electrode roller and the corona electrode. The corona charged laminated PTFE film is thus obtained and collected by wind up rollers.

On base of the project above, the electrical polarization of the laminated films is as follow: the electrodes are coated on both side of the laminated film in the electrode-coating area. And then the laminated film with electrodes is fed into the contact-charging area to be polarized by using contact charging. The charged laminated PTFE film is thus obtained and collected by wind up rollers.

On base of the project above, the laminated PTFE film, exported from the upper and lower heated press rollers, passes through the corona-charging area where it is close to the surface of the electrode roller. And then it is collected by the wind up roller to complete the production of PTFE piezoelectret film.

On base of the project above, two compact PTFE layers with a thickness of 2˜40 μm and one porous PTFE layer with a thickness of 2˜400 μm are used. The porous PTFE layer is sandwiched between the two compact PTFE layers, forming layer stacks. The layer stacks are then thermally bonded and form a laminated film by a pair of the upper and lower heated press rollers. The surfaces of the upper and lower heated press rollers are with cross patterns. The diameters of the upper and lower heated press rollers are of 150 mm. The temperatures of the upper and lower heated press rollers are in the range of 100 to 450° C. The pressures, applied to the film stacks by the upper and lower heated press rollers, are in the range of 0.1 to 200 MPa. The speed of the film stacks going through the upper and lower heated press rollers is in the range of 0.1 to 20 m/min. The laminated PTFE films are fabricated after the treatment of the thermal bonding. The laminated PTFE films are then electrically polarized in the corona-charging area. The voltage of the corona charging is in the range of 1 to 200 kV. The distance between the corona electrode and the electrode roller is in the range of 0.1 to 50 cm. The temperature in the corona area is in the range of −40 to 380° C. PTFE piezoelectret films are fabricated after the treatment of corona charging.

On base of the project above, an electrode coating system and a contact charging system are set between the upper, lower heated press rollers and the wind up roller. The laminated PTFE film exported from the upper and lower heated press rollers first enters the electrode coating system, forming good electrodes on both side of the films, and then goes into the contact charging system under the driving of the wind up roller. A high DC voltage is applied to the upper and lower electrodes of the laminated PTFE film to complete polarization. Finally, the polarized laminated PTFE film is collected by wind up rollers and the fabrication of PTFE piezoelectret film is ready.

On base of the project above, two compact PTFE layers with a thickness of 20˜200 μm and one porous PTFE layer with a thickness of 20˜1000 μm are used. The porous PTFE layer is sandwiched between the two compact PTFE layers, forming layer stacks. The layer stacks are then thermally bonded and form a laminated film by a pair of the upper and lower heated press rollers. The surfaces of the upper and lower heated press rollers are with cross patterns. The diameters of the upper and lower heated press rollers are of 150 mm. The temperatures of the upper and lower heated press rollers are in the range of 150 to 550° C. The pressures, applied to the film stacks by the upper and lower heated press rollers, are in the range of 2 to 400 MPa. The speed of the film stacks going through the upper and lower heated press rollers is in the range of 0.5 to 60 m/min. The laminated PTFE films are fabricated after the treatment of the thermally bonding. The fabricated laminated PTFE film then enters the electrode coating system and aluminum electrodes, with a thickness of 2˜1000 nm, are coated on both sides of the laminated PTFE film. After that, a DC voltage in the range of 100˜20000V is applied to the upper and lower electrodes on the surfaces of the laminated PTFE film. The temperature of the contact charging system is set to be −40-380° C. The PTFE piezoelectet film is fabricated after contact charging.
The PTFE electromechanical energy conversion functional films, produced by the continuous production process, consist of at least two compact PTFE layers, and the layer stacks are formed by using at least one porous PTFE layer sandwiched between every two adjacent compact PTFE layers

Specifically, the electromechanical function films are laminated films consisting porous PTFE layers and compact PTFE layers in a sequential cascade arrangement. The number of layers of porous PTFE is n, n≧1. The number of layers of compact PTFE is n+1. For example, a PTFE piezoelectret film consisting of one porous PTFE layer sandwiched in two compact PTFE layers. Another example is a PTFE piezoelectret film consisting of two porous PTFE layers sandwiched in three compact PTFE layers.

The advantages of this invention lie in that the production process is continuous and high production efficiency. The electromechanical energy conversion functional films, based on PTFE, exhibit an excellent piezoelectric effect and improved thermal stability.

### BRIEF DESCRIPTION OF THE DRAWINGS

FIG. 1 is the schematic views of the micro structure, space charge distribution, and piezoelectric mechanism of piezoelectrets.

FIG. 2 is the schematic of the process for fabricating PTFE piezoelectret films by using corona charging.

FIG. 3 is the schematic of the process for fabricating PTFE piezoelectret films by using contact charging.

FIG. 4 is the piezoelectric d₃₃ coefficient as a function of applied pressure in the Example 1.

FIG. 5 is the isothermal decay of piezoelectric d₃₃ coefficient at 120° C. of the PTFE piezoelectret film in the Example 1.

FIG. 6 is the isothermal decay of piezoelectric d₃₃ coefficient at 200° C. of the PTFE piezoelectret film in the Example 1.

FIG. 7 is the schematic of the structure for a PTFE piezoelectret film.

Label instructions

| | | |
|---|---|---|
| 1—electrode | 2—electret matrix | 3—positive space charge |
| 4—air bubble | 5—negative space charge | 6—compact PTFE layer |
| 7—porous PTFE | 8—compact PTFE layer | 9—upper heated press |
| layer | | roller |
| 10—lower heated | 11—corona electrode | 12—electrode roller |
| press roller | | |
| 13—wind up roller | 14—electro | |
| | coating system | |

15, 16—contact charging system (15: high voltage DC power supplier.
16: electrode)

### DETAILED DESCRIPTION OF THE IMPLEMENTATIONS

### Example 1

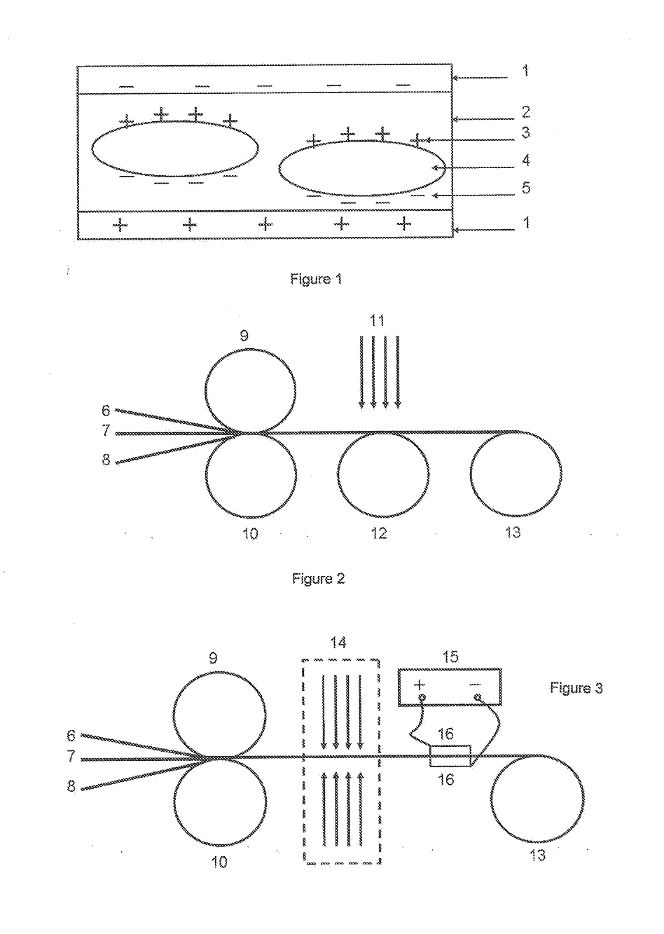

FIG. 1 shows the microstructure and charge distribution of a piezoelectret involved in the present invent, and the schematic view of the piezoelectric effect in such material. A continuous production process for fabricating the electromechanical energy conversion functional films based on PTFE consists of two steps of a thermally bonding of layer stacks with void structure and an electrical polarization.

The steps for the thermal bonding of the laminated films with void structure are as followings. A porous PTFE layer with a thickness of 5 μm (7) is sandwiched by two 5 μm thick compact PTFE layers (6 and 8). And then the stacks of layers are fed into a pair of heated press rollers (9, 10) and thermally bonded by them. The diameters of the heated press rollers are 150 mm. The surfaces of the heated press rollers are with cross patterns. The temperatures of the heated press rollers are set at 150° C. The pressure of the rollers applying on the film system is 1 MPa. The speed of the film system between the two rollers is 0.5 m/min. After the hot pressing, a laminated PTFE film with micro porous structure is obtained.

FIG. 2 shows the schematics of the process for fabricating PTFE piezoelectret films by using corona charging. The corona charging for a laminated PTFE film is performed by feeding the laminated PTFE film into the corona charging area formed by electrode rollers 11 and 12. The corona voltage is 20 kV. The distance between the electrode roller (12) and corona electrode (11) is 4 cm. The temperature in the corona area is 25° C. After the treatment of corona charging, PTFE piezoelectret film is obtained. The PTFE piezoelectret film is finally collected by a wind up roller 13.

The test results of the PTEF piezoelectret film with microporous structure mentioned above are as followings.

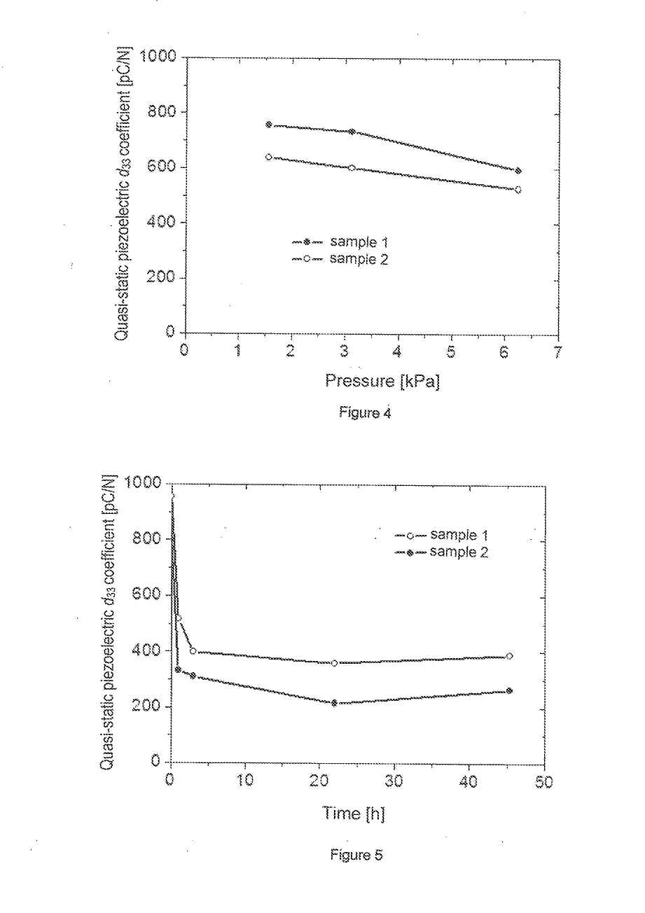

FIG. 4 shows the quasi-static d₃₃ coefficient of a PTEF piezoelectret sample as a function of applied pressure. This figure indicates that the quasi-static d₃₃ coefficients up to 800 pC/N are achieved, which is much larger than the d₃₃ values of commercial PP piezoelectret films (OS01:25 pC/N; HS01:230 pC/N). This figure also indicates that the piezoelectric d₃₃ in the PTFE piezoelectret sample has relatively good linearity in the applied pressure of 1 to 6 kPa. Results on the isothermal decay of the quasi-static d₃₃ coefficients in PTFE piezoelectret samples at an annealing temperature of 120° C. are shown in FIG. 5. The values of d₃₃ decrease in the initial stage of annealing (within 3 hours). After 3 hours annealing, d₃₃ coefficients remain in the level of 200 to 400 pC/N. These results indicate that the thermal stability of piezoelectric effect in PTFE piezoelectret films is much better than that in commercial PP piezoelectret films. The working temperature of PP piezoelectret films is less than 60° C., and a strong deformation can happen and the piezoelectric effect disappears when the PP piezoelectret films are annealed at 120° C.).

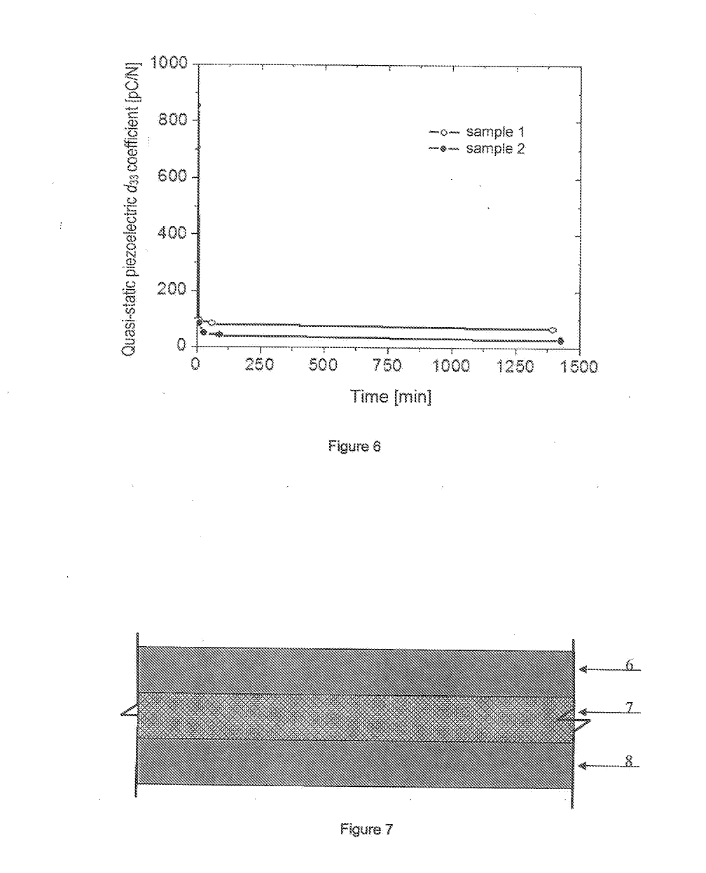

Results on the isothermal decay of the quasi-static d₃₃ coefficients in PTFE piezoelectret samples at an annealing temperature of 200° C. are shown in FIG. 6. By the pre-aging treatment of the PTFE piezoelectret films, fabricated by using the process described in Example 1, thermally stable piezoelectret films, with a work temperature of 200° C., can be obtained.

### Example 2

Set an electrode coating system (14) and a contact charging system (15,16) between a pair of heated press rollers (9,10) and the wind up roller (13).

A continuous production process for fabricating the electromechanical energy conversion functional films based on PTFE consists of two steps of a thermal bonding of layer stacks with void structure and an electrical polarization.

The steps for the thermal bonding of the laminated films with void structure are as followings. A porous PTFE layer with a thickness of 400 μm is sandwiched by two 20 μm thick compact PTFE layers. And then the stacks of layers are fed into a pair of heated press rollers (9, 10) and thermally bonded by them. The diameters of the heated press rollers are 150 mm. The surfaces of the heated press rollers are with cross patterns. The temperatures of the heated press rollers are set at 420° C. The pressure of the rollers applying on the film system is 200 MPa. The speed of the film system between the two rollers is 32 m/min. After the hot pressing, a laminated PTFE film with micro porous structure is obtained.

FIG. 3 shows the schematics of the process for fabricating PTFE piezoelectret films by using contact charging. The contact charging for a laminated PTFE film is performed by feeding the laminated PTFE film into the electrode coating system 14 (electrode coating area). Both sides of the films are metallized by aluminum electrodes evaporation 100 nm in thickness. After that, a DC voltage of 8000V is applied between the aluminum electrodes. The temperature in the contact charging area (15,16) is 25° C. After the treatment of contact charging, PTFE piezoelectret film is obtained. The PTFE piezoelectret film is finally collected by a wind up roller 13.

The products, fabricated by using the present invention, consist of porous PTFE layers and compact PTFE layers in a sequential cascade arrangement. The number of layers of porous PTFE is n, n≧1. The number of layers of compact PTFE is n+1. For example, a PTFE piezoelectret film consisting of one porous PTFE layer sandwiched in two compact PTFE layers. Another example is a PTFE piezoelectret film consisting of two porous PTFE layers sandwiched in three compact PTFE layers.

The quasi-static piezoelectric d₃₃ coefficient in film, fabricated in the Example 2, is 1362 pC/N at an applied pressure of 3.2 kPa, indicating that even more strong piezoelectric effect can be achieved by an optimization of electric polarization parameters.

### Example 3

A porous PTFE layer with a thickness of 2 μm (7) is sandwiched by two 50 μm thick compact PTFE layers (6 and 8). And then the stacks of layers are fed into a pair of heated press rollers (9, 10) and thermally bonded by them. The diameters of the heated press rollers are 150 mm. The surfaces of the heated press rollers are with cross patterns. The temperatures of the heated press rollers are set at 150° C. The pressure of the rollers applying on the film system is 200 MPa. The speed of the film system between the two rollers is 10 m/min. After the hot pressing, a laminated PTFE film with micro porous structure is obtained.

FIG. 2 shows the schematics of the process for fabricating PTFE piezoelectret films by using corona charging. The corona charging for a laminated PTFE film is performed by feeding the laminated PTFE film into the corona charging area formed by electrode rollers 11 and 12. The corona voltage is 20 kV. The distance between the electrode roller (12) and corona electrode (11) is 4 cm. The temperature in the corona area is 25° C. After the treatment of corona charging, PTFE piezoelectret film is obtained. The PTFE piezoelectret film is finally collected by a wind up roller 13.

The quasi-static piezoelectric d₃₃ coefficient in film, fabricated in the Example 3, is 998 pC/N at an applied pressure of 3.2 kPa.

### Example 4

A porous PTFE layer with a thickness of 1000 μm (7) is sandwiched by two 200 μm thick compact PTFE layers (6 and 8). And then the stacks of layers are fed into a pair of heated press rollers (9, 10) and thermally bonded by them. The diameters of the heated press rollers are 150 mm. The surfaces of the heated press rollers are with cross patterns. The temperatures of the heated press rollers are set at 550° C. The pressure of the rollers applying on the film system is 400 MPa. The speed of the film system between the two rollers is 60 m/min. After the hot pressing, a laminated PTFE film with micro porous structure is obtained.

FIG. 2 shows the schematics of the process for fabricating PTFE piezoelectret films by using corona charging. The corona charging for a laminated PTFE film is performed by feeding the laminated PTFE film into the corona charging area formed by electrode rollers 11 and 12. The corona voltage is 20 kV. The distance between the electrode roller (12) and corona electrode (11) is 4 cm. The temperature in the corona area is 25° C. After the treatment of corona charging, PTFE piezoelectret film is obtained. The PTFE piezoelectret film is finally collected by a wind up roller 13.

The quasi-static piezoelectric d₃₃ coefficient in film, fabricated in the Example 4, is 1928 pC/N at an applied pressure of 3.2 kPa.

### Example 5

A porous PTFE layer with a thickness of 500 μm (7) is sandwiched by two 40 μm thick compact PTFE layers (6 and 8). And then the stacks of layers are fed into a pair of heated press rollers (9, 10) and thermally bonded by them. The diameters of the heated press rollers are 150 mm. The surfaces of the heated press rollers are with cross patterns. The temperatures of the heated press rollers are set at 450° C. The pressure of the rollers applying on the film system is 200 MPa. The speed of the film system between the two rollers is 0.5 m/min. After the hot pressing, a laminated PTFE film with micro porous structure is obtained.

FIG. 2 shows the schematics of the process for fabricating PTFE piezoelectret films by using corona charging. The corona charging for a laminated PTFE film is performed by feeding the laminated PTFE film into the corona charging area formed by electrode rollers 11 and 12. The corona voltage is 20 kV. The distance between the electrode roller (12) and corona electrode (11) is 4 cm. The temperature in the corona area is 25□. After the treatment of corona charging, PTFE piezoelectret film is obtained. The PTFE piezoelectret film is finally collected by a wind up roller 13.

The quasi-static piezoelectric d₃₃ coefficient in film, fabricated in the Example 5, is 2446 pC/N at an applied pressure of 3.2 kPa.

1-8. (canceled)

9. A process for fabricating a polytetrafluoroethene (PTFE) functional film, comprising:
applying thermal bonding of a stack of layers comprising at least one porous PTFE layer between at least two compact PTFE layers to form a laminated film; and
performing electrical polarization on the laminated film for achieving the PTFE functional film.

10. The process according to claim 9, wherein said applying comprises feeding the stack of layers between two heated press rollers for thermally bonding the stack.

11. The process according to claim 9, wherein said performing comprises corona charging.

12. The process according to claim 11, wherein said performing further comprises placing the laminated film between an electrode roller and a corona electrode for said corona charging.

13. The process according to claim 9, wherein said performing comprises:
coating the laminated film with conductive layers, one layer on each side of the laminated film; and
electrically charging the laminated film coated with the conductive layers.

14. The process according to claim 13, wherein said electrically charging comprises contact charging.

15. The process according to claim 9, further comprising:
winding up the PTFE functional film into a roll, and wherein said applying, said performing and said winding up are carried out in a continuous fashion.

16. The process according to claim 9, wherein each of said at least two compact PTFE layers has a thickness between 2 and 40 microns.

17. The process according to claim 9, wherein said at least one porous PTFE layer has a thickness between 2 and 400 microns.

18. The process according to claim 10, wherein the heated press rollers have a temperature between 100 and 450° C.

19. The process according to claim 10, wherein the heated press rollers are arranged to apply a pressure on the stack of layers in the range of 0.1 to 200 MPa, and said feeding is carried out at a speed in a range of 0.1 to 20 m/min.

20. The process according to claim 11, wherein said corona charging is performed at a voltage range of 1 to 200 kV.

21. The process according to claim 12, wherein the electrode roller and the corona electrode has a gap in a range of 0.1 to 50 cm.

22. The process according to claim 13, wherein each of said at least two compact PTFE layers has a thickness between 20 and 200 microns.

23. The process according to claim 13, wherein said at least one porous PTFE layer has a thickness between 20 and 1000 microns.

24. The process according to claim 13, wherein said applying comprises feeding the stack of layers between two heated press rollers for thermally bonding the stack, and wherein the heated press rollers have a temperature between 150 and 550° C.

25. The process according to claim 24, wherein the heated press rollers are arranged to apply a pressure on the stack of layers in the range of 2 to 400 MPa and said feeding is carried out at a speed in a range of 0.5 to 60 m/min.

26. The process according to claim 10, wherein each of the heated press rollers has a roller surface with cross patterns.

27. The process according to claim 13, wherein each of the conductive layers comprises an aluminum layer with a thickness between 2 and 1000 nm, and said electrically charging is carried out by a DC voltage in a range of 100-20000V.

28. The process according to claim 27, wherein said electrically charging is carried out in a contact charging system at −40 to 380° C.
